(19) United States
(12) Patent Application Publication
(10) Pub. No.: US 2006/0280026 A1
(43) Pub. Date: Dec. 14, 2006

(54) Device for and method of continuous mixing of light concrete and the use of a combined transporting and mixing screw in such a device

(76) Inventor: Hakan Dackefjord, Stockholm (SE)

Correspondence Address: Ralph A. Dowell of DOWELL & DOWELL P.C., 2111 Eisenhower Ave, Suite 406, Alexandria, VA, 22314, US

(21) Appl. No.: 10/548,624

(22) PCT Filed: Mar. 10, 2004
(86) PCT No.: PCT/SE04/00259

§ 371 Date: Aug. 18, 2006

(30) Foreign Application Priority Data
Mar. 13, 2003 (SE) 0300688-9

(51) Int. Cl. B28C 5/14

(52) U.S. Cl. 366/8; 366/50; 366/64; 366/320; 366/324; 366/325.3; 366/327.3; 366/326.1

(57) ABSTRACT

The invention is related to a device for the continuous mixing of lightconcrete comprising density decreasing particles, concrete and water, characterised by an elongated mixing chamber (1) in which a screw (4) is rotatably arranged around the central axis (5) of the cylinder (1). The screw is provided with two parts, a first transporting screw part (6) and a second combined transporting and mixing screw part (7). At the free end of the transporting screw part (6), a first feeding device (13) for the supply of density decreasing particles is arranged, and at the transition between the two different screw parts (6,7), a second feeding device (14) for the supply of a concrete/water mixture is arranged. The density decreasing particles are transported by means of the transporting screw part (6) into the combined transporting and mixing screw part (7), in-order to be mixed therein into a homogenous mass of at least density decreasing particles, concrete and water, and wherein at the same time, the mass is output from the free end of the combined transporting and mixing screw part (7). The invention is further related to a method of continuous mixing, and the use of a combined transporting and mixing screw.

The present invention relates to a device and method for continuous mixing of lightconcrete comprising filler particles, cement and water.

### BACKGROUND TECHNIQUE

The mixing of lightconcrete including filler particles, such as polymer particles and/or haydite particles, as a density decreasing material requires forced mixing due to the differences in density between the separate materials included. Typically, the lightconcrete is mixed at the supplier and is transported to the working site by means of a container. Once the first container has been emptied, it is transported back to the supplier and is refilled with mixed lightconcrete. The lightconcrete arrives in batches to the working site.

Another variant is that a concrete truck containing mixed lightconcrete is transported between the supplier and the working site. The concrete truck has a slowly rotating drum in order to maintain the mixture so as to keep it homogenous, but cannot perform the basic mixing.

### SUMMARY OF THE INVENTION

It is an object of the present invention to obtain a device and method that decreases, among other things, the costs and difficulties associated with the production of lightconcrete.

The invention defined in claims 1, 8 and 12 enables the mixing of the lightconcrete directly at the working site, and furthermore the mixing of exactly the amount required at any occasion. Another advantage is that the device can easily be cleaned during breaks in the mixing, without major losses of time and materials. Yet another advantage is that a minor amount of water can be used since the lightconcrete is moulded directly on the spot, therefore no additional water is needed during the storing period, and consequently this continuously mixed lightconcrete will dry quicker.

As the skilled person readily understands, the lightconcrete comprises, if desired, also added ingredients, such as shrink reducing agents, hardening accelerating or retarding agents or plasticizers.

In order to further simplify the mixing when polymer particles are used, shrink reducing agents may be applied to the polymer particles at an earlier stage. Preferably at the same time the polymer particles are finished antistatically.

### BRIEF DESCRIPTION OF THE DRAWINGS

The present invention will now be described by way of example by means of a preferred embodiment along with the attached drawings, in which:

FIG. 1 illustrates a first embodiment of the inventive device with parts being cut out.

FIG. 2 illustrates an end view of a combined transporting and mixing screw, according to the present invention.

FIG. 3 illustrates an embodiment of the feeding devices, according to the present invention.

FIG. 4 illustrates an embodiment of an adjustable screw blade pitch, as seem in an end view.

FIG. 5 illustrates the assembly according to the embodiment in FIG. 4 in a separated position.

FIG. 6 illustrates the assembly according to the embodiment in FIG. 4 in an assembled position.

FIG. 7 illustrates a second embodiment of a combined transporting and mixing screw, according to the present invention.

FIG. 8 illustrates a third embodiment of a combined transporting and mixing screw, according to the present invention.

### DETAILED DESCRIPTION OF PREFERRED EMBODIMENTS

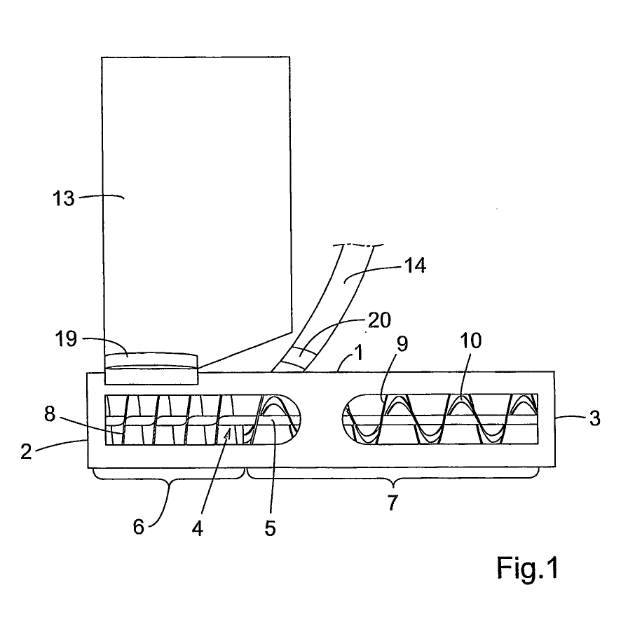

In FIG. 1, a device according to a first embodiment of the present invention is illustrated. The device comprises a mixing chamber 1, here in the shape of a cylinder, which is closed at a first end 2 and open at a second end 3. Parts of the cylinder 1 are cut out in FIG. 1, in order to illustrate a screw 4 that is rotatably mounted therein. In reality, the cylinder has intact walls, of course. The screw 4 is arranged centrally and can be rotated around its central axis 5 during operation, e.g. by means of a motor (not shown).

The screw 4 comprises a first part, a transporting screw part 6 and a second part, a combined transporting and mixing screw part 7, where the two parts have a common central axis 5 and rotate together during operation. The transporting screw part 6 is provided with an intact screw blade 8 protruding helically and radially from the central axis 5 with a desired pitch along the central axis 5.

In a first embodiment, the combined transporting and mixing screw part 7 comprises an exterior screw blade 9 having an open centre, helically and concentrically extending around the central axis 5 with a desired pitch along the same. The exterior screw blade 9 is slanted so as to thrust the material inside the cylinder 1 towards the free end of the combined transporting and mixing screw part 7, and thereby the open end 3 of the cylinder 1.

Inside the exterior screw blade 9, an interior screw blade 10 is arranged having an open centre and extending helically and concentrically around the central axis 5 with a desired pitch along the same. The interior screw blade 10 is slanted so as to thrust the material inside the cylinder 1 towards the transition between the two screw parts 6 and 7.

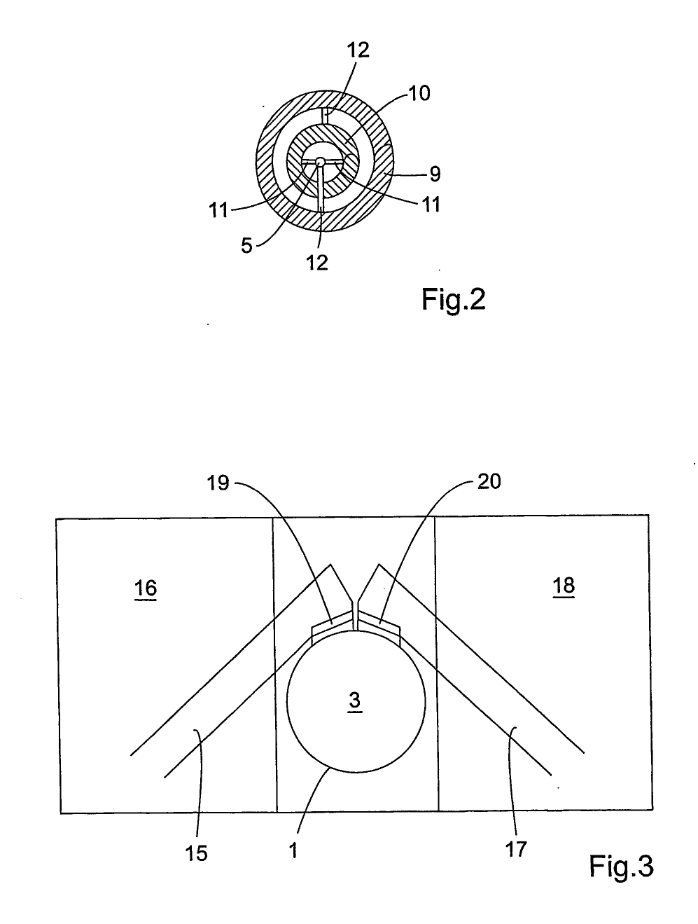

At least at certain points, the interior screw blade 10 is attached to the central axis 5, e.g. by means of struts 11 at suitable intervals essentially along the entire screw part 7. At least at certain points, the exterior screw blade 9 is directly attached to the central axis 5, or attached to the central axis 5 via the interior screw blade 10. Preferably, the exterior screw blade 9 is also attached by means of struts 12 at suitable intervals essentially along the entire screw part 7, see FIG. 2.

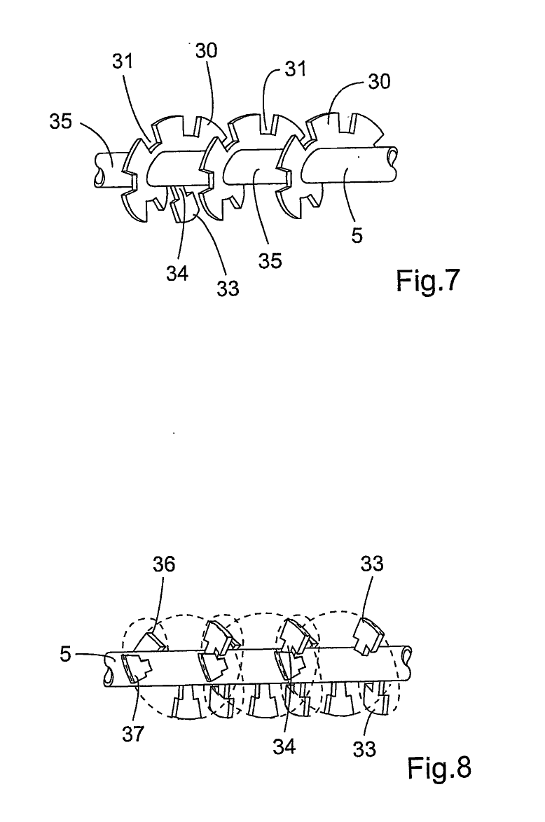

According to a second embodiment of the combined transporting and mixing screw part 7, it comprises a screw blade 30 extending radially outwards from the inside of central axis 5, see FIG. 7. The screw blade 30 is provided with recesses 31 at its periphery, for the mixing of the materials. If desired, separate paddles 33 arranged on struts 34 may further be provided in the interspaces 35 of the screw blade 30.

According to a third embodiment of the combined transporting and mixing screw part 7, it comprises solely separate paddles 33 arranged on struts 34, see FIG. 8. The angles of the paddles 33 are set to form two imaginary screw lines around the central axis 5. At one 36 of the screw lines, where the paddles are preferably arranged further out from the central axis 5, the paddles 33 are slanted so as to transport the materials to be mixed towards the open end 3 of the cylinder 1. The other 37 screw line, where the paddles 33 are preferably arranged closer to the central axis 5, the paddles 33 are slanted so as to transport the materials to be mixed back towards the transition between the two screw parts 6 and 7. In order to adjust the pitch of the screw lines 36, 37, the angle of the paddles 33 is changed relative to the central axis 5.

In this way, the different materials to be homogenously mixed, are compulsively mixed at the same time also being transported towards the open end 3 of the cylinder 1. When the materials reach the open end 3 of the cylinder 1, a homogenous mass of the included materials has been produced, and the mass is fed out for transfer to the moulding spot at the working site.

A first feeding device 13 for the feeding of density decreasing particles is arranged so as to feed density decreasing particles at the beginning of the transporting screw part 6, i.e. at its free end, through an opening in the cylinder 1. Preferably, the feeding device is equipped with a dosing means 19, such that the amount of supplied density decreasing particles can be controlled and adjusted as required and desired.

A second feeding device 14 for the feeding of at least one concrete/water mixture is arranged such that the concrete/water mixture is fed at the transition between the two screw parts 6 and 7, or at the beginning of (as seen in the main direction of transport) the combined transporting and mixing screw part 7. Preferably, also the second feeding device 14 is equipped with a dosing means 20, such that the amount of supplied concrete/water mixture can be controlled and adjusted as required and desired.

As readily understood by a skilled person, the concrete/water mixture may of course include added ingredients, such as shrink reducing agents, hardening accelerating or retarding agents or plasticizers.

In the first embodiment of the combined transporting and mixing screw part 7, at least one, but preferably both, of the interior and exterior screw blades 10 and 9 is/are adjustable with respect to the pitch of the screw blade along the axis, in order to provide an increased or decreased thrust of the material, if desired.

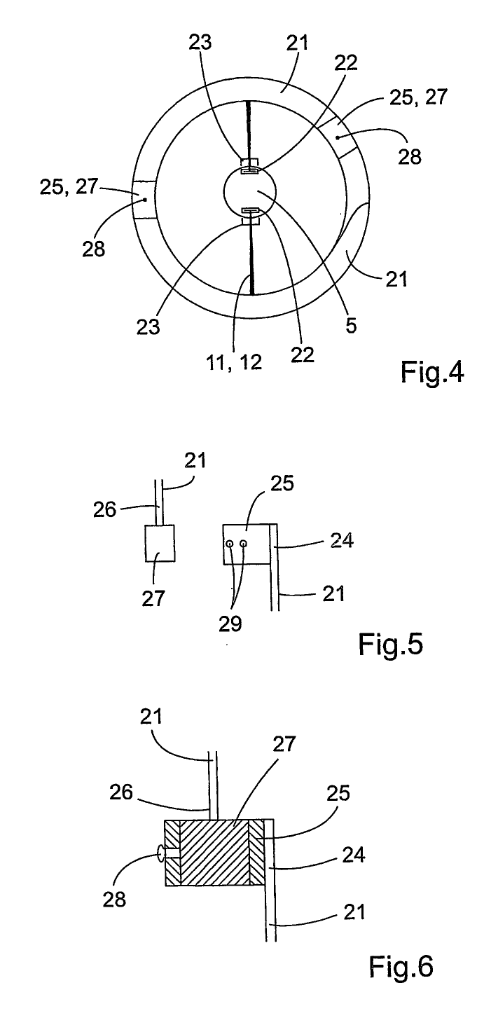

This may be accomplished by the adjustable screw blade 9, 10 being somewhat elastic and/or segmented 21, e.g. in semi circles, see FIG. 4, 5 and 6. The struts 11, 12 attaching the screw blade 9, 10 to the central axis 5 are movably arranged at the central axis 5, e.g. by means of screw fastenings for securing the struts more frequently, providing a finer pitch of the screw helix 9, 10, or less frequently, providing a coarser pitch of the screw helix 9, 10, along the central axis 5.

The struts 11, 12 may be arranged displaceable in tracks 22 and be threaded next to the central axis 5, such that a locking nut 23 can be tightened against the central axis in order to lock the strut 11, 12 in a selected position. Preferably, a certain space is provided for turning the strut 11, 12 around the longitudinal axis of the strut 11, 12.

If connected segments 21 are used, these may be secured to each other by having a female connector 25 at one end 24, e.g. a cylinder pipe, and a male connector 27 at the other end 26, e.g. a rod or a cylinder pipe of smaller diameter than the inner diameter of the female connector 25, such that the male connector 27 can be introduced into the female connector 25.

In order to prevent free rotation between the female and male connectors, a stop screw 28 may be arranged in one of, e.g., four apertures 29 for the stop screw 28 distributed in the female connector 25, so as to provide a suitable angle between the segments 21 for different pitches of the screw blade 9, 10.

Preferably, density decreasing particles are fed to the first feeding device 13 by means of a first transport screw 15 from a first storage container 16, and in the same manner, the concrete/water mixture is fed by means of a second transport screw 17 from a second storage container 18 to the second feeding device 14, see FIG. 3.

The procedure of mixing lightconcrete comprising density decreasing particles, concrete and water according to the invention, is executed such that the density decreasing particles are supplied to an opening at the first end 2 of the cylinder 1, and hence the free end of the transporting screw part 6. The density decreasing particles are transported by means of the rotating transporting screw part 6 towards the second combined transporting and mixing screw part 7.

The concrete/water mixture is supplied approximately at the transition between the two screw parts 6 and 7. The density decreasing particles are compulsively mixed with the concrete/water mixture into a homogenous mass, at the same time as the mass is transported towards the free end, the output end, of the rotating combined transporting and mixing screw part 7, in the course of increased mixing and homogenisation of the mass.

Since added ingredients are typically used, it is advantageous if one or more of these are applied to the density decreasing particles in a pretreating operation. If polymer particles are used, this preferably takes place at the same time as the polymer particles are finished antistatically. For example, a shrink reducing agent dissolved in an alcohol may be applied to the polymer particles, after which the shrink reducing agent attaches to the surface of the polymer particles, and the alcohol evaporates leaving the shrink reducing agent behind.

Then, as the treated polymer particles are mixed with the concrete/water mixture, the water will dissolve out the shrink reducing agent such that it mixes with the concrete and can accomplish the intended effect of the agent. In a particularly preferred embodiment, the shrink reducing agent also acts as an antistatic agent. By pretreating the polymer particles, the arrangement of a further feeding device can be avoided, which would require a very accurate dosing means.

Cleaning of the device is simply done by choking the supply of density decreasing particles at the same time as the transporting screw part 6 still rotates, such that the density decreasing particles are fed to the combined transporting and mixing screw part 7. Instead of feeding the concrete/water mixture at the second feeding device 14, water is pumped in, advantageously under heavy pressure, such that the water rinses the inside of the cylinder, and the remainder of the mass washed out by the water is ejected through the open end 3 of the cylinder 1.

Thus, a device and a method for continuous mixing of lightconcrete comprising density decreasing particles, concrete and water, has been provided that can be operated to mix exactly the desired quantity of lightconcrete, at the moment being required or desired at a working site. The mixing process can be terminated and the device can be easily cleaned, to be taken into operation again immediately. For the sake of simplicity, the device can be mounted in a container, in order to be easily transported to the different building sites.

1. A device for the continuous mixing of lightconcrete comprising density decreasing particles, concrete and water, characterised by an elongated mixing chamber (1) in which a screw (4) is rotatably arranged around the central axis (5) of the mixing chamber (1), the screw is provided with two parts, a first transporting screw part (6) and a second combined transporting and mixing screw part (7), at the free end of the transporting screw part (6), a first feeding device (13) for the supply of density decreasing particles is arranged, and at the transition between the two different screw parts (6,7), a second feeding device (14) for the supply of a concrete/water mixture is arranged, such that the density decreasing particles are transported by means of the transporting screw part (6) into the combined transporting and mixing screw part (7), in order to be mixed therein into a homogenous mass of at least density decreasing particles, concrete and water, and wherein at the same time, the mass is output from the free end of the combined transporting and mixing screw part (7).

2. A device according to claim 1, wherein the combined transporting and mixing screw part (7) comprises a concentrically arranged exterior spiral blade (9) having an open centre at some points attached to the central axis (5) of the screw part, and a concentrically arranged interior spiral blade (10) at least at some points attached to the central axis (5) of the screw part.

3. A device according to claim 2, wherein the exterior spiral blade (9) is adapted to transport the included materials to be mixed towards the free end of the combined transporting and mixing screw part (7), and the interior spiral blade (10) is adapted to transport the included materials to be mixed towards the transition between the two different screw parts (6,7).

4. A device according to claim 2 wherein the exterior spiral blade (9) is adjustably arranged with respect to the pitch of the exterior spiral blade (9) along the central axis (5) at the combined transporting and mixing screw part (7).

5. A device according to claim 2 wherein the interior spiral blade (10) is adjustably arranged with respect to the pitch of the interior spiral blade (10) along the central axis (5) at the combined transporting and mixing screw part (7).

6. A device according to claim 1, wherein the transporting screw part (6) comprises an intact helical screw blade (8) protruding radially outwards from the axis (5) of the transporting screw part (6).

7. A device according to claim 1, wherein the feeding devices (13,14) are provided with dosing means (19,20) for adjusting the input flow.

8. A method of continuous mixing of lightconcrete comprising density decreasing particles, concrete and water, characterised in that polymer particles are supplied to a first end (2) of a mixing chamber (1) having a centrically rotatable screw (4) arranged therein, wherein the density decreasing particles are transported by means of a first rotating transporting screw part (6) of the screw (4) towards a second combined transporting and mixing screw part (7), wherein a concrete/water mixture is supplied at the transition between the different screw parts (6,7), after which the density decreasing particles are mixed with the concrete/water mixture into a homogenous mass, at the same time as the mass is transported towards the free end, the output end, of the rotating combined transporting and mixing screw part (7).

9. A method according to claim 8, wherein the density decreasing particles are polymer particles.

10. A method according to claim 9, wherein the polymer particles are pretreated by applying a shrink reducing agent to the polymer particles, which takes place at the same time as an antistatic finish of the polymer particles.

11. A method according to claim 10, wherein the shrink reducing agent also acts as an antistatic agent.

12. The use of a combined transporting and mixing screw (6,7) in a device according to claim 1 for mixing of at least density decreasing particles, concrete and water.
